(19) United States
(12) Patent Application Publication
(10) Pub. No.: US 2022/0003716 A1
(43) Pub. Date: Jan. 6, 2022

(54) ULTRASONIC INSPECTION FOR CERAMIC STRUCTURES

(71) Applicant: CORNING INCORPORATED, Corning, NY (US)

(72) Inventors: Natarajan Gunasekaran, Painted Post, NY (US); Prashanth Abraham Vanniamparambil, Glen Burnie, MD (US); Ryan Spencer Wilhelm, Addison, NY (US)

(21) Appl. No.: 17/294,052

(22) PCT Filed: Nov. 4, 2019
(86) PCT No.: PCT/US2019/059595

§ 371 Date: May 14, 2021

Related U.S. Application Data
(60) Provisional application No. 62/767,671, filed on Nov. 15, 2018.

(51) Int. Cl. G01N 29/04; G01N 29/09; B01D 46/24

(52) U.S. Cl. CPC G01N 29/043; G01N 2291/0232; B01D 46/2422; G01N 29/09

(57) ABSTRACT

Methods, systems, and devices for ultrasonic inspection for ceramic structures are described. The method may include transmitting, via an ultrasonic transmitter, an ultrasonic waveform through the ceramic structure, where the ceramic structure includes two opposing ends and one or more outer faces extending between the two opposing ends, the one or more outer faces being at least partially enclosed by a casing and the ultrasonic transmitter being positioned adjacent to a first of the two opposing ends. The method may also include receiving a propagated waveform via an ultrasonic receiver positioned adjacent to a second of the two opposing ends and generating an image based at least in part on the propagated waveform, the image illustrating at least a portion of the casing and one or more detected features of the ceramic structure at the one or more outer faces of the ceramic structure adjacent to the casing.

This application claims the benefit of priority under 35 U.S.C. § 119 of U.S. Provisional Application No. 62/767,671 filed on Nov. 15, 2018, the content of which is incorporated herein by reference in its entirety.

### BACKGROUND

The following relates generally to ultrasonic inspection for ceramic structures.

Catalytic converters may be widely used to develop emission control systems in various applications such as vehicle and engine manufacturing, non-road engines, and other machine manufacturing. In some cases, catalytic converters may convert toxic gases and pollutants in exhaust gas into less-toxic pollutants by catalyzing a redox reaction. In catalytic converters or in addition to catalytic converters, substrate and filtration products may be implemented to reduce emissions, optimize power, and improve fuel economy. For example, a substrate may be coated with a metal catalyst to convert gases such as oxides of nitrogen, carbon monoxide, and hydrocarbons to gases such as nitrogen, carbon dioxide, and water vapor.

Substrates or honeycomb filters may be used in emissions systems (e.g., catalytic converter systems, exhaust systems). Various features (e.g., defects, cracks, or microscopic damage) of a substrate may arise during regular operation or during production, for example. These features, however, may be difficult to identify using traditional contact and non-contact inspection techniques.

### SUMMARY

The described features generally relate to methods, systems, devices, or apparatuses that support ultrasonic inspection for ceramic structures. A method for detecting features of a ceramic structure is described. The method may comprise transmitting, via an ultrasonic transmitter, an ultrasonic waveform through the ceramic structure, where the ceramic structure comprises two opposing ends and one or more outer faces extending between the two opposing ends, the one or more outer faces being at least partially enclosed by a casing and the ultrasonic transmitter being positioned adjacent to a first of the two opposing ends, receiving a propagated waveform via an ultrasonic receiver positioned adjacent to a second of the two opposing ends, the propagated waveform being the ultrasonic waveform after traversal of the ceramic structure, and generating an image based at least in part on the propagated waveform, the image illustrating at least a portion of the casing and one or more detected features of the ceramic structure at the one or more outer faces of the ceramic structure adjacent to the casing.

Some examples of the method described herein may further comprise enclosing the one or more outer faces of the ceramic structure with the casing, where the casing has a first acoustic impedance that is within a predetermined range of a second acoustic impedance of the ceramic structure. In some examples, enclosing the one or more outer faces may comprise sliding the casing around the ceramic structure. In some examples, enclosing the one or more outer faces may comprise coupling first and second body portions of the casing around the ceramic structure.

In some examples, transmitting the ultrasonic waveform through the ceramic structure comprises transmitting the ultrasonic waveform through an air-ceramic structure interface at the first of the two opposing ends.

Some examples of the method described herein may further comprise adjusting a signal strength or gain of the ultrasonic waveform, and detecting a feature of the ceramic structure in the image based on the adjusted signal strength or gain.

In some examples, generating the image comprises scanning the ceramic structure using the ultrasonic receiver to map an internal structure of the ceramic structure based at least in part on the propagated waveform, where the internal structure indicates the one or more detected features.

Some examples of the method described herein may further comprise identifying the one or more detected features of the ceramic structure based on discontinuities illustrated in the image.

Some examples of the method described herein may further comprise adjusting a transducer speed of the ultrasonic transmitter, scanning the ceramic structure using the ultrasonic receiver to map an internal structure of the ceramic structure based at least in part on the adjusted transducer speed, and generating the image based at least in part on the scanning.

In some examples, the ceramic structure comprises a honeycomb filter.

A casing is also described. In some examples, the casing may comprise a sleeve material having a first acoustic impedance that is within a predetermined range of a second acoustic impedance of a honeycomb filter structure having two opposing ends and one or more outer faces extending between the two opposing ends, and an encasing face of the sleeve material that facilitates encasement of at least a portion of the one or more outer faces of the honeycomb filter structure by the sleeve material, the encasing face of the sleeve material being adjacent to the one or more outer faces of the honeycomb filter structure upon encasement of the honeycomb filter structure.

Some examples of the casing described herein may further comprise an encasing mechanism configured to couple first and second encasing portions of the encasing face, where the first and second encasing portions surround at least the portion of the one or more outer faces of the honeycomb filter structure upon encasement of the honeycomb filter structure when the first and second encasing portions are coupled.

Some examples of the casing described herein may further comprise an internal lining material positioned between the encasing face and the one or more outer faces of the honeycomb filter structure upon encasement of the honeycomb filter structure.

In some examples, the internal lining material comprises a polymer sheet, Styrofoam, rubber bladder, modeling clay, or any combination thereof. In some examples, the encasing face facilitates encasement of at least the portion of the one or more outer faces of the honeycomb filter structure by the sleeve material in a horizontal or vertical direction. In some examples, the encasing face is configured to be adjacent to only the one or more outer faces of the honeycomb filter structure.

In some examples, a cross-sectional shape of the casing is different from a cross-sectional shape of the honeycomb filter structure. In some examples, the sleeve material comprises a rubber sheet, a polymeric sheet, Styrofoam, a ceramic mat, a plastic sheet, a metallic material, or any combination thereof.

A system is also described. In some examples, the system may comprise an ultrasonic transmitter positioned adjacent to a first of two opposing ends of a porous ceramic structure, where one or more outer faces extending between the two opposing ends of the porous ceramic structure are at least partially enclosed by a casing, the ultrasonic transmitter configured to transmit an ultrasonic waveform through the porous ceramic structure, an ultrasonic receiver positioned adjacent to a second of the two opposing ends and configured to receive a propagated waveform of the ultrasonic waveform after traversal of the porous ceramic structure, and a processor configured to generate an image based at least in part on the propagated waveform, the image illustrating at least a portion of the casing and one or more detected features of the porous ceramic structure at the one or more outer faces of the porous ceramic structure adjacent to the casing.

In some examples, a distance between the ultrasonic transmitter and the ultrasonic receiver is greater than a height of the porous ceramic structure. In some examples, the ultrasonic receiver is aligned with and in a direction of transmission of the ultrasonic transmitter.

In some examples, the ultrasonic receiver is movable along an axis perpendicular to a direction of transmission of the ultrasonic transmitter. In some examples, the casing surrounds the one or more outer faces of the porous ceramic structure and comprises a rubber sheet, a polymeric sheet, Styrofoam, a ceramic mat, a plastic sheet, a metallic material, or any combination thereof.

Some examples of the system described herein may further comprise a base plate configured to support one of the two opposing ends of the porous ceramic structure, the base plate positioned perpendicular to an axis between the ultrasonic transmitter and the ultrasonic receiver.

### BRIEF DESCRIPTION OF THE DRAWINGS

FIG. 1 illustrates an example emissions system component that supports ultrasonic inspection for ceramic structures in accordance with examples of the present disclosure.

FIG. 2 illustrates an example inspection system that supports ultrasonic inspection for ceramic structures in accordance with examples of the present disclosure.

FIG. 3A illustrates an example casing system that supports ultrasonic inspection for ceramic structures in accordance with examples of the present disclosure.

FIG. 3B illustrates an example casing system that supports ultrasonic inspection for ceramic structures in accordance with examples of the present disclosure.

FIG. 3C illustrates an example casing system that supports ultrasonic inspection for ceramic structures in accordance with examples of the present disclosure.

FIG. 4A illustrates an example mapping that supports ultrasonic inspection for ceramic structures in accordance with examples of the present disclosure.

FIG. 4B illustrates an example mapping that supports ultrasonic inspection for ceramic structures in accordance with examples of the present disclosure.

FIG. 5A illustrates an example signal gain table that supports ultrasonic inspection for ceramic structures in accordance with examples of the present disclosure.

FIG. 5B illustrates an example signal gain table that supports ultrasonic inspection for ceramic structures in accordance with examples of the present disclosure.

FIG. 6 illustrates an example system that supports ultrasonic inspection for ceramic structures in accordance with examples of the present disclosure.

FIG. 7 illustrates an example system that supports ultrasonic inspection for ceramic structures in accordance with examples of the present disclosure.

FIG. 8 illustrates a method that supports ultrasonic inspection for ceramic structures in accordance with examples of the present disclosure.

FIG. 9 illustrates a method that supports ultrasonic inspection for ceramic structures in accordance with examples of the present disclosure.

### DETAILED DESCRIPTION

Ceramic honeycomb cellular substrates and filters have been used to reduce the amount of harmful exhaust entering the ambient atmosphere (e.g., from vehicle exhaust). In diesel engine emission control systems, ceramic honeycomb substrates may be used as particulate filters in the exhaust system as well as in catalytic converter systems, while a similar concept is also implemented in gasoline powered engines (e.g., with a direct injection configuration).

Quality inspection after manufacturing ceramic substrates (or after use of a substrate) may include non-destructive analysis such as a light box, ping test, nebulizer (iTest), etc. Other non-destructive test methods such as ultrasonic method, X-ray method (computed tomography (CT) scan), etc., may be used to complement (or may be used in the alternative to) such processes. In ultrasonic testing, contact pulse echo and non-contact ultrasonic (NCU) (also referred as air coupled ultrasonic method) may be used to identify substrate features. Such techniques may complement each other through the identification of different types of features or flaws. For example, contact pulse echo may be used to identify radial features or flaws such as cracks, while NCU may be used for axial feature or flaw detection.

According to some aspects, a sample holding apparatus or staging procedure may be utilized to enhance image quality during NCU inspection of ceramic substrates. Rather than a free standing sample (e.g., in ambient atmosphere), a substrate sample may be enclosed in a sleeve, housing, or casing, or wrapped in foam or other polymeric material prior to an NCU scanning process. This enclosure process may provide enhanced imaging results after performing an NCU scan and in some cases, the generated image may have increased resolution and higher quality throughout and particularly around the substrate skin or surface regions. Additionally or alternatively, adjusting an ultrasonic receiver or transmitter position (e.g., the distance or angle with respect to one another) may improve image contrast and assist in reducing false positives during inspection of the substrate.

Features of the disclosure introduced above are further described below in the context of ultrasonic inspection for ceramic structures. NCU setup, systems, and operations are illustrated and depicted in the context of ultrasonic inspection for ceramic structures. These and other features of the disclosure are further illustrated by and described with reference to apparatus diagrams, system diagrams, and flowcharts that relate to ultrasonic inspection for ceramic structures.

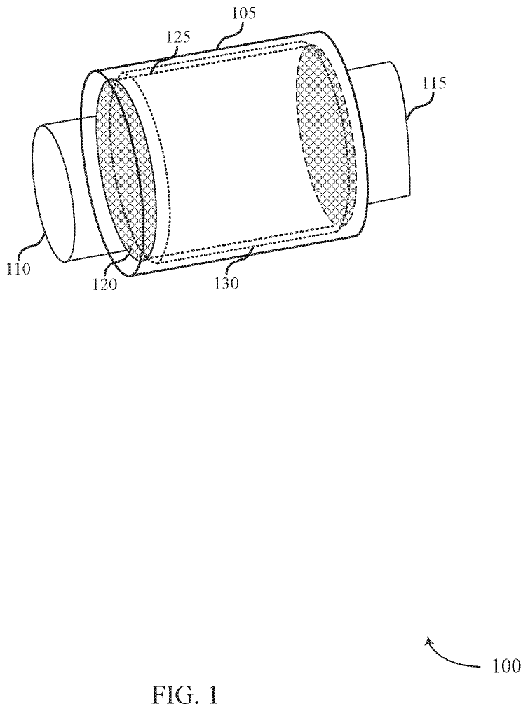

FIG. 1 illustrates an example emissions system component 100 that supports ultrasonic inspection for ceramic structures in accordance with various examples of the present disclosure. Emissions system component 100 may comprise an outer shell 105, an inlet 110, and an outlet 115. Emissions system component 100 may also comprise a substrate 120 housed within the outer shell 105, for example, and the substrate 120 may comprise an outer surface 125. The emissions system component 100 may also comprise a sleeve 130 (e.g., a fabric or other material) positioned between the outer surface 125 and the outer shell 105, which may be used to hold the substrate 120 within housing 105.

The emissions system component 100 may be an example of an exhaust emission control device that converts toxic gases and pollutants in exhaust gas into less-toxic pollutants by catalyzing a redox reaction (e.g., a catalytic converter). The emissions system component 100 may be implemented within internal combustion engines fueled by either gasoline or diesel. For example, the emissions system component 100 may be implemented in automobiles, electrical generators, forklifts, mining equipment, locomotives, motorcycles, etc. In some cases, the emissions system component 100 may be implemented in lean-burn engines such as kerosene heaters, stoves, or the like.

In some aspects, the emissions system component 100 may transform gas and pollutants that enter through inlet 110 into less-toxic pollutants that exit though outlet 115. For example, gases such as oxides of nitrogen, carbon monoxide, and hydrocarbons may enter through inlet 110 and may exit the emissions system component 100 as gases such as nitrogen, carbon dioxide, and water vapor. In such a case, an oxidation and reduction reaction (e.g., redox reaction) may occur within the emissions system component 100 to convert the toxic gases (e.g., emissions) into less harmful gases for the environment. The emissions system component 100 may reduce emissions and increase the fuel economy.

To convert the toxic gases into less-toxic pollutants, the emissions system component 100 may comprise the substrate 120. The substrate 120 may be an example of a honeycomb filter made of a ceramic material that in some cases may act as a carrier of a metal catalyst. For example, an interior surface of the substrate 120 may be coated with the metal catalyst. In that case, the toxic gases may flow into the emissions system component 100 through inlet 110, react with the metal catalyst coated on the interior surface of the substrate 120, and exit the emissions system component 100 through outlet 115 as converted less-toxic gases. In other examples, the substrate 120 may comprise multiple honeycomb layers configured to trap particulates of exhaust gas passing through the substrate 120.

The substrate 120 may be encased within the outer shell 105. For example, the outer surface 125 may abut an inside surface (e.g., mat material) of the outer shell 105. In some cases, the substrate 120 may be encased within the outer shell 105 by establishing a frictional barrier and maintaining radial pressure between the outer surface 125 of the substrate 120 and the inner surface of the outer shell 105 or the sleeve 130. In some examples, if the radial pressure is less than a threshold to maintain the substrate 120 within the outer shell 105, the substrate 120 may move within the outer shell 105, which may result in inefficient conversion or particulate retention. In other examples, if the radial pressure is more than a threshold to maintain the substrate 120 within the outer shell, 105, the substrate 120 may be damaged during use (e.g., the outer surface 125 may incur one or more defects or the substrate 120 may break).

After manufacturing, or after use, a substrate 120 may be inspected to identify features such as defects, cracks, surface wear, surface profiles, etc. Using a non-destructive inspection method (e.g., NCU) may be beneficial as it may allow for use of the substrate 120 after inspection (as opposed to a destructive method that may be more invasive or may render the substrate 120 useless after inspection). Placing the substrate 120 in ambient atmosphere without an enclosure may be used to inspect internal damages, however, false positives may occur during identification of axial and face features due to constraints involved in the detection of damages on the outer regions. Thus, the inspection techniques described herein may comprise the use of air coupled pulser and receiver configuration (e.g., an ultrasonic transmitter or transducer configured to transmit ultrasonic waves through the substrate 120 to be received by an ultrasonic receiver or transducer) together with a sample of the substrate 120 wrapped or enclosed with an inert material such as a rubber sheet, a polymeric sheet, Styrofoam, a ceramic mat, a plastic sheet, etc. Such techniques may be used to reduce noise at an material-air boundary and aide in the identification of axial and face features of the substrate 120.

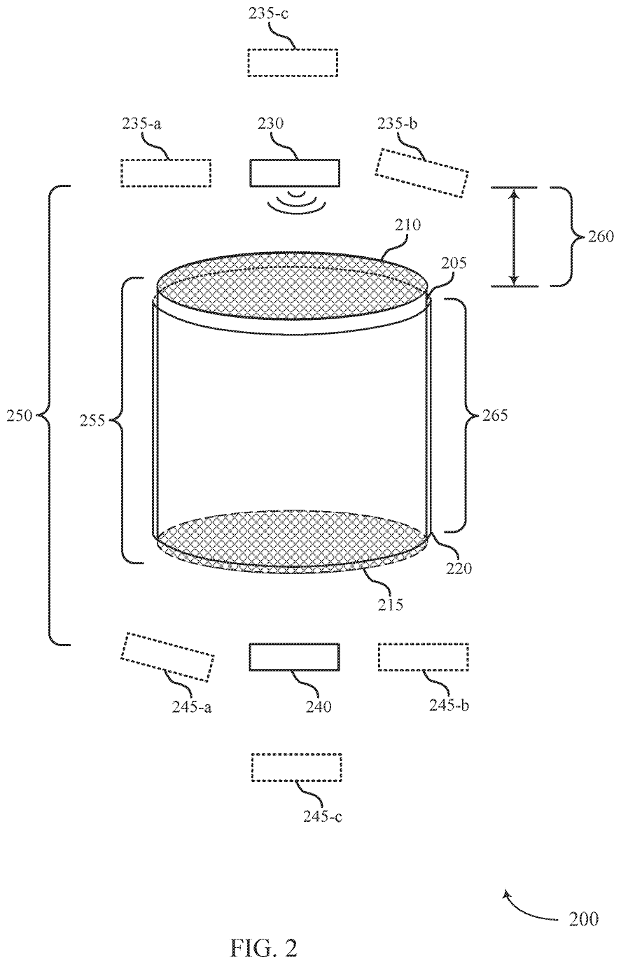

FIG. 2 illustrates an example inspection system 200 that supports ultrasonic inspection for ceramic structures in accordance with examples of the present disclosure. The system 200 may comprise a substrate 205. The substrate 205 may comprise top surface 210 and bottom surface 215 opposite the top surface 210. In some cases, the substrate 205 may comprise or may be enclosed by a casing 220. The substrate 205 may be an example of the substrate as described with reference to FIG. 1.

The inspection system 200 may be an NCU inspection system or other non-contact or non-invasive inspection system for inspecting a substrate 205. The inspection system 200 may be used to identify features of the substrate 205 such as axial or face features including cracks, flaws, defects, etc. The inspection system 200 may also be used to detect or identify internal features of the substrate 205. These identification or detection techniques may be facilitated through the use of ultrasonic waves or other signals, as described herein. Though not shown, a base plate may be used to support one of the top surface 210 or the bottom surface 215 of the substrate 205. The base plate may be positioned perpendicular to an axis between a transmitter 230 and receiver 240.

The inspection system 200 may comprise a transmitter 230, which may be an ultrasonic transmitter or transducer. As shown, the transmitter 230 is positioned adjacent to (e.g., above) the top surface 210 of the substrate 205 and not in contact with the substrate 205. While the transmitter 230 is shown as being centered above the substrate 205, the transmitter 230 may be positioned in various positions and in some cases, may be angled or rotated. For example, the transmitter 230 may be positioned along a horizontal axis above the substrate 205 such as at position 235-a or 235-b. Additionally or alternatively, the transmitter 230 may be rotated or angled, as in position 235-b. Further, the transmitter 230 may be positioned along a vertical axis with respect to the substrate 205. For instance, the transmitter 230 may be positioned at position 235-c. The different positions 235 or angles may allow for enhanced imaging quality (e.g., increased contrast, higher resolution) during inspection, which may reduce false positives during feature detection.

The transmitter 230 may be configured to transmit ultrasonic waves or other acoustic signals toward the substrate 205, which may propagate through the substrate 205 and received by a receiver 240. The receiver 240 may be an ultrasonic receiver or transducer and may be configured to receive ultrasonic waves or other acoustic signals that have propagated through the substrate 205 (e.g., ultrasonic waves transmitted by transmitter 230). As shown, the receiver 240 is positioned adjacent to (e.g., below) the bottom surface 215 of the substrate 205 and not in contact with the substrate 205. While the receiver 240 is shown as being centered below the substrate 205, the receiver 240 may be positioned in various positions and in some cases, may be angled or rotated. For example, the receiver 240 may be positioned along a horizontal axis below the substrate 205 such as at position 245-a or 245-b. Additionally or alternatively, the receiver 240 may be rotated or angled, as in position 245-b. Further, the receiver 240 may be positioned along a vertical axis with respect to the substrate 205. For instance, the receiver 240 may be positioned at position 245-c. The different positions 245 or angles may allow for enhanced imaging quality (e.g., increased contrast, higher resolution) during inspection, which may reduce false positives during feature detection.

As shown, the transmitter 230 is separated from the receiver 240 by a distance 250. The distance 250 may be greater than a height or axial length 255 of the substrate 205 and as a result, an air gap 260 between the top surface 210 of the substrate 205 and the transmitter 230 is formed. Because an ultrasonic wave has higher attenuation in air than when traveling through the substrate 205 (e.g., made of a ceramic material), the greatest wave spread or scattering observed during inspection may be at the material-air interface (e.g., around the peripheral region of the substrate 205). This may cause a poor image quality after a scan, which may make it difficult to identify features of the substrate 205. During manufacturing inspection, this may result in false positives or misidentification of a feature of the substrate 205, which, may deem the substrate 205 unfit for use and fail a quality inspection when the substrate 205 may have otherwise been fit for use, for example.

According to some aspects, a casing 220 may be used and wrapped or configured to enclose the substrate 205 during an inspection process. The casing 220 may be made of a solid inert material such as a rubber sheet, a polymeric sheet, Styrofoam, a ceramic mat, a plastic sheet, etc. In some examples, the casing 220 may be made of a rigid material such as a metallic material. For example, a higher density material (e.g., in the case of metallic materials), results in a higher speed of sound through the material, which in turn increases the acoustic impedance. In some cases, as the acoustic impedance of the casing 220 increases, ultrasonic waves transmitted by the transmitter 230 would propagate more efficiently from the substrate 205 (e.g., porous ceramic structure) to the casing 220, which may improve image quality generated through NCU testing or other inspection processes.

The casing 220 may comprise layers of a single material of multiple materials and the casing 220 may extend along the height or axial length 255 of the substrate 205. For example, the casing 220 may extend a given length 265, which may enclose a portion of or the entirety of the substrate 205. Utilization of the casing 220 may help reduce or eliminate the scattering observed during inspection (e.g., at the periphery or skin region of substrate 205) by helping to provide a well defined boundary of the substrate in images (or a collection of images) generated through the reception of ultrasonic waves at the receiver 240 during one or more scans.

In some examples, when ultrasonic waves propagate from one material to another, reflection, absorption, and transmission may occur. The amount of reflection, absorption, and transmission is associated with the acoustic impedance (Z) of the medium, as represented by Equation 1 below:

I_{reflected}=(Z2−Z1)²/(Z2+Z1)²(I_{incident}) (1)

In Equation 1, Z1 is the acoustic impedance for material 1, Z2 is the acoustic impedance for material 2, I_{incident} is the energy of the incident wave, and I_{reflected} is the energy reflected. For instance, if an acoustic wave is traveling from material 1 to material 2, where material 1 is a ceramic structure that has a higher acoustic impedance than material 2 (e.g., air), a majority of the energy will be reflected. Thus, a greater acoustic impedance mismatch between material 1 and material 2, the greater the reflection. Alternatively, if Z1 and Z2 are approximately the same, most of the energy may be absorbed by material 2 (i.e., the amount of energy reflected is reduced or is low compared to energy transmitted through) and the transmitted energy may be represented by Equation 2 below:

I_{transmitted}=(2Z2)²/(Z2+Z1)²(I_{incident}) (2)

In Equation 2, I_{transmitted} is the energy of transmitted through material 2 in this example. Here, the transmission is increased when the acoustic impedance of material 2 (Z2) is greater or approximately the same as material 1 (Z1).

Further, the acoustic impedance (Z) of a material, which impacts the amount of acoustic reflection, absorption, and transmission of incident may be represented by Equation 3 as follows:

Z=ρC (3)

In Equation 3, ρ is the density of the material and C is the speed of sound in the material, where the speed of sound for ceramics, for instance, may be determined using Equation 4 as follows:

$$C = \sqrt{\frac{B}{3 ρ ( 1 - 2 v )}} \qquad ( 4 )$$

In Equation 4, B is the Young's modulus and v is Poisson's Ratio. Based on Equation 4, the higher the Young's Modulus, the greater the speed of sound in a material. Further, when the speed of sound in the ceramic material is higher, the acoustic impedance of the material is also greater. For instance, the speed of sound in air is 340 meters per second (m/s). When ultrasonic waves travel from a denser material (e.g., a ceramic material) to a less dense material (e.g., air), a majority of the energy of the incident waves are reflected back into the denser material (e.g., as shown in Equation 1), which may make it difficult for inspection system 200 utilizing NCU techniques to image the edges of the substrate 205 with sufficient resolution (i.e., the air gap 260 causes a majority of energy to be reflected when waves travel from air to the substrate 205 and as a result, less energy is transmitted through the substrate 205). To help reduce these deleterious imaging effects, the casing 220 that encloses the substrate 205 may be of a material with higher density and a greater Young's modulus, which increases the acoustic impedance of the material to which the ultrasonic are transmitted and reduces the acoustic impedance of the substrate 205 and air. This may provide a greater transmission of ultrasonic waves through the substrate 205 at the interface between the air gap 260 and the substrate which increases image resolution at the edges and provides a well-defined boundary.

The inspection system 200 may be utilized to detect or identify features such as cracks or other flaws in the substrate 205. Time of flight (TOF) through a medium is inversely proportional to the speed of sound according to Equation 5:

TOF=d/C (5)

In Equation 5, d is the distance between the transmitter 230 and receiver 240. As the speed of sound in air differs from the speed of sound in the substrate 205 (e.g., a porous ceramic material), the ultrasonic signals that have propagated through the substrate 205 and have been received by the receiver 240 will be separated in time. To identify feature or discontinuities of the substrate 205 (e.g., a crack in the material), the propagated ultrasonic waves will be attenuated (e.g., the received signal strength will be reduced) and may be delayed at the receiver 240. A loss in signal strength and or a delay may allow for the detection or absences of discontinuities in the substrate 205 and may also provide an internal image of the substrate 205 through a scan of the entire porous ceramic structure.

The inspection system 200 described herein may improve a Signal to Noise Ratio (SNR) during inspection of a substrate 205. For instance, the inspection system 200 may provide an enhanced image resolution around the outer surface or skin regions of the substrate 205 through the use of casing 220. The inspection system 200 may help reduce the scattering of ultrasonic wave around edges of the substrate 205, which increase SNR and may make axial or face features more apparent during detection.

The inspection system 200 described herein may increase imaging resolution. For example, as more energy is transmitted into the substrate 205 rather than reflected back toward the transmitter 230, image quality and contrast may be enhanced. This enhancement may help reduce false positive interpretation during image analysis and detection of substrate 205 features.

The inspection system 200 described herein may be a cost effective design. The casing 220 may be a plastic holder and may comprise a lining material such as polymer sheet, Styrofoam, rubber bladder, modeling clay, etc. Such materials may allow increased energy transmission of the ultrasonic waves into the substrate with a reduced reflection or loss. According to some aspects, any low cost solid material may be used for the casing 220 (e.g., so long as there is minimal adherence to or reach with the substrate 205).

The inspection system 200 described herein may increase the quality of inspection of a substrate 205. In some cases, the substrate 205 may be subject to a canning process in which a mat material and stainless steel may be used. Damages that may occur during the canning process may be identified using NCU techniques and the inspection system 200.

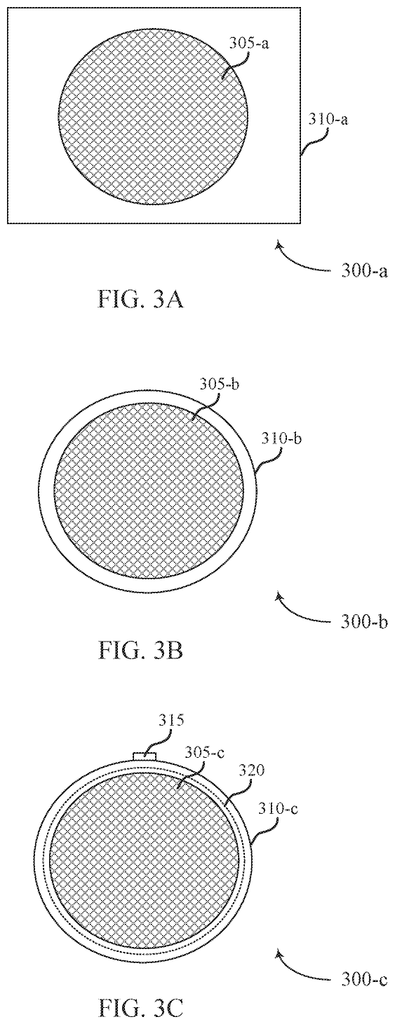

FIG. 3A illustrates an example casing system 300-a that supports ultrasonic inspection for ceramic structures in accordance with examples of the present disclosure. The system 300-a may comprise a substrate 305-a and a casing 310-a. The substrate 305-a and the casing 310-a may be an example of the substrate and casing as described with reference to FIGS. 1 and 2.

In FIG. 3A, a cross-sectional view of substrate 305-a and casing 310-a is shown. Casing 310-a is wrapped or enclosed about the outer surface of substrate 305-a. Casing 310-a may extend along a length of the substrate 305-a and in some cases, may extend along an entirety of the substrate 305-a. While the cross-section of substrate 305-a is illustrated as circular, the cross-section of substrate 305-a may be any shape. In some examples, the cross-section of casing 310-a may have a different shape (e.g., rectangular) than the cross-section of substrate 305-a, as shown. Further, the casing 310-a may vary in width and amount of material surrounding the substrate 305-a and in some cases, may not be symmetric about the substrate 305-a.

The casing 310-a may be made of a solid inert material such as a rubber sheet, a polymeric sheet, Styrofoam, a ceramic mat, a plastic sheet, etc. In some examples, the casing 310-a may be made of a rigid material such as a metallic material. The casing 310-a may comprise layers of a single material of multiple materials. Utilization of the casing 310-a may help reduce or eliminate the scattering observed during inspection (e.g., at the periphery or skin region of substrate 305-a) by helping to provide a defined boundary of the substrate in images (or a collection of images) generated during one or more NCU scans.

FIG. 3B illustrates an example casing system 300-b that supports ultrasonic inspection for ceramic structures in accordance with examples of the present disclosure. The system 300-b may comprise a substrate 305-b and a casing 310-b. The substrate 305-b and the casing 310-b may be an example of the substrate and casing as described in reference to FIGS. 1 and 2.

In FIG. 3B, a cross-sectional view of substrate 305-b and casing 310-b is shown. Casing 310-b is wrapped or enclosed about the outer surface of substrate 305-b. Casing 310-b may extend along a length of the substrate 305-b and in some cases, may extend along an entirety of the substrate 305-b. While the cross-section of substrate 305-b is illustrated as circular, the cross-section of substrate 305-b may be any shape. In some examples, the cross-section of casing 310-b may have the same shape (e.g., circular) as the cross-section of substrate 305-b, as shown. Further, the casing 310-b may vary in width and amount of material surrounding the substrate 305-b and in some cases, may not be symmetric about the substrate 305-b.

The casing 310-b may be made of a solid inert material such as a rubber sheet, a polymeric sheet, Styrofoam, a ceramic mat, a plastic sheet, etc. In some examples, the casing 310-b may be made of a rigid material such as a metallic material. The casing 310-b may comprise layers of a single material of multiple materials. Utilization of the casing 310-b may help reduce or eliminate the scattering observed during inspection (e.g., at the periphery or skin region of substrate 305-b) by helping to provide a defined boundary of the substrate in images (or a collection of images) generated during one or more NCU scans.

FIG. 3C illustrates an example casing system 300-c that supports ultrasonic inspection for ceramic structures in accordance with examples of the present disclosure. The system 300-c may comprise a substrate 305-c, a casing 310-c, and clamp 315. The substrate 305-c and the casing 310-c may be an example of the substrate and casing as described in reference to FIGS. 1 and 2.

In FIG. 3C, a cross-sectional view of substrate 305-c and casing 310-c is shown. Casing 310-c is wrapped or enclosed about the outer surface of substrate 305-c. Casing 310-c may extend along a length of the substrate 305-c and in some cases, may extend along an entirety of the substrate 305-c. While the cross-section of substrate 305-c is illustrated as circular, the cross-section of substrate 305-c may be any shape. In some examples, the cross-section of casing 310-c may have the same shape (e.g., circular) as the cross-section of substrate 305-c, as shown. Further, the casing 310-c may vary in width and amount of material surrounding the substrate 305-c and in some cases, may not be symmetric about the substrate 305-c.

In some examples, casing 310-c may be a clamshell type structure that connects on end of the casing 310-c to a second end of the casing 310-c using a hinge 315 or other bracket or coupling mechanism. Further, although not shown, multiple hinges 315 may be used to connect portions of the casing 310-c to other portions, or to add durability or stability to the casing 320-c.

According to some aspects, a liner material 320 may be used in conjunction with the casing 310-c, which may decrease the acoustic impedance mismatch between materials and allow for enhanced imaging during NCU inspection. The liner material 320 may be made of a solid inert material such as a rubber sheet, a polymeric sheet, Styrofoam, a ceramic mat, a plastic sheet, and in some examples may be made of modeling clay that is pliable or moldable. In some instances, the liner material 320 may be configured to secure the substrate 305-c with respect to the casing 310-c.

The casing 310-c may be made of a solid inert material such as a rubber sheet, a polymeric sheet, Styrofoam, a ceramic mat, a plastic sheet, etc. In some examples, the casing 310-c may be made of a rigid material such as a metallic material. The casing 310-c may comprise layers of a single material of multiple materials. Utilization of the casing 310-c may help reduce or eliminate the scattering observed during inspection (e.g., at the periphery or skin region of substrate 305-c) by helping to provide a defined boundary of the substrate in images (or a collection of images) generated during one or more NCU scans.

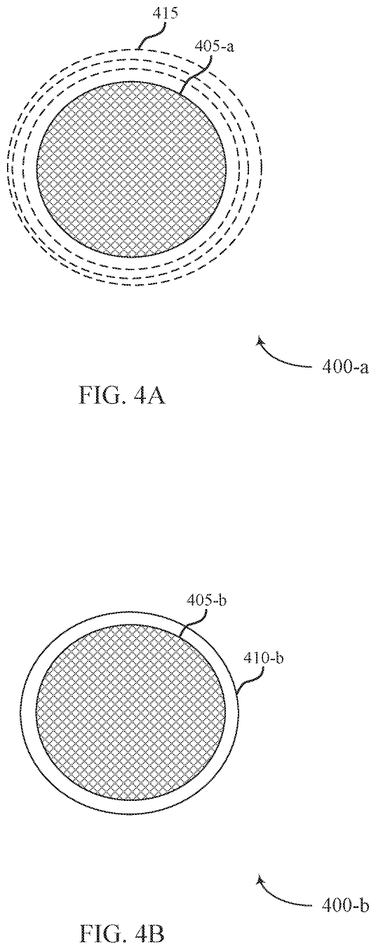

FIG. 4A illustrates an example mapping 400-a that supports ultrasonic inspection for ceramic structures in accordance with examples of the present disclosure. The mapping 400-a may comprise a substrate 405-a and one or more rings 415. The substrate 405-a may be an example of the substrate as described in reference to FIGS. 1-3.

In FIG. 4A, a cross-sectional view of substrate 405-a is shown after NCU mapping without a casing. As illustrated in FIG. 4A, in the absence of the casing, there is a “halo effect” shown by the one or more rings 415 at the edges of the substrate 405-a. Such an effect may cause inaccurate discontinuity detection or false positives due to poor image quality.

FIG. 4B illustrates an example mapping 400-b that supports ultrasonic inspection for ceramic structures in accordance with examples of the present disclosure. The mapping 400-b may comprise a substrate 405-b and a casing 410-b. The substrate 405-b and the casing 410-b may be an example of the substrate and casing as described in reference to FIGS. 1-3.

In FIG. 4B, a cross-sectional view of substrate 405-b and casing 410-b is shown. Casing 410-b is wrapped or enclosed about the outer surface of substrate 405-b. Casing 410-b may extend along a length of the substrate 405-b and in some cases, may extend along an entirety of the substrate 405-b. While the cross-section of substrate 405-b is illustrated as circular, the cross-section of substrate 405-b may be any shape. In some examples, the cross-section of casing 410-b may have the same shape (e.g., circular) as the cross-section of substrate 405-b, as shown. Further, the casing 410-b may vary in width and amount of material surrounding the substrate 405-b and in some cases, may not be symmetric about the substrate 405-b.

The casing 410-b may be made of a solid inert material such as a rubber sheet, a polymeric sheet, Styrofoam, a ceramic mat, a plastic sheet, etc. In some examples, the casing 410-b may be made of a rigid material such as a metallic material. The casing 410-b may comprise layers of a single material of multiple materials. In FIG. 4B, the “halo effect” illustrated in FIG. 4A is eliminated resulting in a reduced number of rings. Utilization of the casing 410-b may help reduce or eliminate the scattering observed during inspection (e.g., at the periphery or skin region of substrate 405-b) by helping to provide a defined boundary of the substrate in images (or a collection of images) generated during one or more NCU scans, as shown.

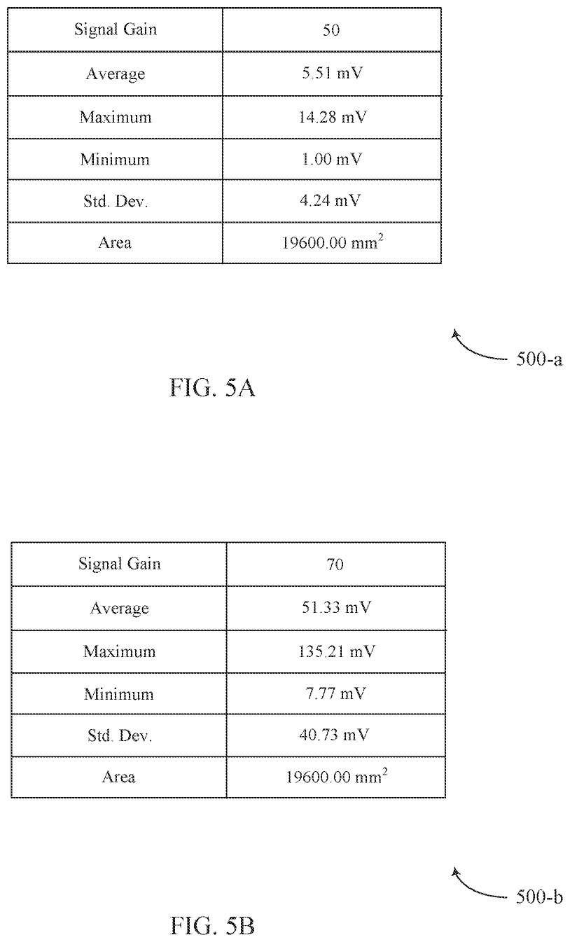

FIGS. 5A and 5B illustrate example signal gain tables 500 that support ultrasonic inspection for ceramic structures in accordance with examples of the present disclosure.

Some parameters of an inspection system described herein may be varied or modified to increase the effectiveness of the casing used to enclose a substrate during NCU testing or other inspection processes. For instance, increasing the signal gain may have a positive effect in the detection of features in a substrate (e.g., due to a higher signal to loss ratio (SLR)). As shown in gain table 500-a of FIG. 5A, a transmitted signal gain of 50 dB results in an average of 5.51 millivolts (mV) signal strength received at the receiver. As the signal gain increases from 50 dB to 70 dB, as shown in gain table 500-b of FIG. 5B, the received signal strength also increases to an average of 51.33 mV, which is almost 10 times greater than the signal strength received using a 50 dB gain. The resulting image quality may also be enhanced with increased received signal strength.

Other parameters of an inspection system such as that which is described herein may be varied to positively affect the image generated from scanning. For instance, increasing the transmitted signal strength may help increase the SLR at the receiver to identify the presence of discontinuities in the material and map the internal structure of the substrate.

As the signal strength increases (e.g., from 300 Volts (V) to 390 V), the received signal strength may increase from 51.3 mV to 65.3 mV, which may increase the image quality. Other parameters such as transducer speed may reduce the scanning time as seen in Table 1 below.

TABLE 1

| Transducer Speed | Total Scanning Time |
|---|---|
| (mm/s) | (minutes) |
| 100 | 5 |
| 90 | 5.2 |
| 80 | 5.5 |
| 70 | 6.24 |
| 60 | 7.11 |
| 50 | 8.16 |

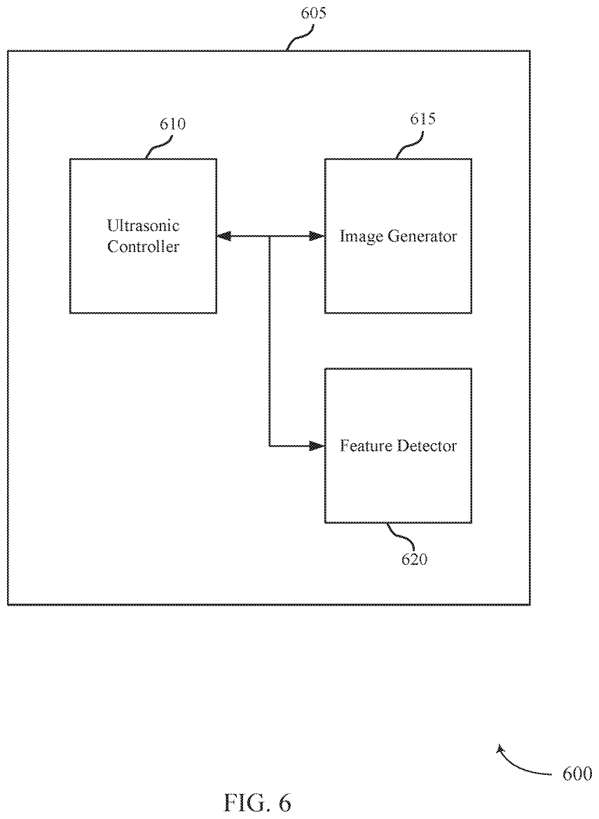

FIG. 6 shows an example block diagram 600 of a system 605 that supports ultrasonic inspection for ceramic structures in accordance with examples of the present disclosure. System 605 may be referred to as an electronic apparatus, and may be an example of a component of a controller.

System 605 may comprise an ultrasonic controller 610, an ultrasonic transmitter controller 615, an image generator 615, and a feature detector 620. These components may be in electronic communication with each other and may perform one or more of the functions described herein. These components may also be in electronic communication with other components, both inside and outside of system 605, in addition to components not listed above, via other components, connections, or busses.

The ultrasonic controller 610 may be configured to transmit an ultrasonic waveform through the ceramic structure, where the ceramic structure comprises two opposing ends and one or more outer faces extending between the two opposing ends, the one or more outer faces being at least partially enclosed by a casing and the ultrasonic transmitter being positioned adjacent to a first of the two opposing ends. In some cases, the ultrasonic controller 610 may transmit the ultrasonic waveform through an air-ceramic structure interface at the first of the two opposing ends. The ultrasonic controller 610 may be configured to adjusting a transducer speed of the ultrasonic transmitter. In some cases, the ultrasonic controller 610 may be configured to adjust a signal strength or gain of the ultrasonic waveform.

The ultrasonic controller 610, or at least some of its various sub-components may be implemented in hardware, software executed by a processor, firmware, or any combination thereof. If implemented in software executed by a processor, the functions of the ultrasonic controller 610 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The ultrasonic controller 610 and/or at least some of its various sub-components may be physically located at various positions, comprising being distributed such that portions of functions are implemented at different physical locations by one or more physical devices. In some examples, the ultrasonic controller 610 and/or at least some of its various sub-components may be a separate and distinct component in accordance with various examples of the present disclosure. In other examples, the ultrasonic controller 610 and/or at least some of its various sub-components may be combined with one or more other hardware components, comprising but not limited to a receiver, a transmitter, a transceiver, one or more other components described in the present disclosure, or a combination thereof in accordance with various examples of the present disclosure.

The ultrasonic controller 610 may be configured to receive a propagated waveform positioned adjacent to a second of the two opposing ends, the propagated waveform being the ultrasonic waveform after traversal of the ceramic structure. In some cases, the ultrasonic controller 610 may be configured to scan the ceramic structure using the ultrasonic receiver to map an internal structure of the ceramic structure based at least in part on the propagated waveform, where the internal structure indicates the one or more detected features. The ultrasonic controller 610 may be configured to scan the ceramic structure using the ultrasonic receiver to map an internal structure of the ceramic structure based at least in part on the adjusted transducer speed.

The ultrasonic controller 610, or at least some of its various sub-components may be implemented in hardware, software executed by a processor, firmware, or any combination thereof. If implemented in software executed by a processor, the functions of the ultrasonic controller 610 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The ultrasonic controller 610 and/or at least some of its various sub-components may be physically located at various positions, comprising being distributed such that portions of functions are implemented at different physical locations by one or more physical devices. In some examples, the ultrasonic controller 610 and/or at least some of its various sub-components may be a separate and distinct component in accordance with various examples of the present disclosure. In other examples, the ultrasonic controller 610 and/or at least some of its various sub-components may be combined with one or more other hardware components, including but not limited to a receiver, a transmitter, a transceiver, one or more other components described in the present disclosure, or a combination thereof in accordance with various examples of the present disclosure.

In some cases, ultrasonic controller 610 may be in electronic communication with the image generator 615. The image generator 615 may generate an image based at least in part on the propagated waveform, the image illustrating at least a portion of the casing and one or more detected features of the ceramic structure at the one or more outer faces of the ceramic structure adjacent to the casing. In some cases, the image generator 615 may generate the image based at least in part on the scanning.

The image generator 615, or at least some of its various sub-components may be implemented in hardware, software executed by a processor, firmware, or any combination thereof. If implemented in software executed by a processor, the functions of the image generator 615 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The image generator 615 and/or at least some of its various sub-components may be physically located at various positions, including being distributed such that portions of functions are implemented at different physical locations by one or more physical devices. In some examples, the image generator 615 and/or at least some of its various sub-components may be a separate and distinct component in accordance with various examples of the present disclosure. In other examples, the image generator 615 and/or at least some of its various sub-components may be combined with one or more other hardware components, including but not limited to a receiver, a transmitter, a transceiver, one or more other components described in the present disclosure, or a combination thereof in accordance with various examples of the present disclosure.

The feature detector 620 may be in electronic communication with the image generator 615 and/or the ultrasonic controller 610. For example, the feature detector 620 may detect a feature of the ceramic structure at the one or more outer faces of the ceramic structure, the feature being detectable based at least in part on the one or more outer faces being at least partially enclosed by the casing. In some cases, the feature detector 620 may detect a feature of the ceramic structure in the image based at least in part on the adjusted signal strength or gain. In some cases, the feature detector 620 may identify the one or more detected features of the ceramic structure based at least in part on discontinuities illustrated in the image.

The feature detector 620, or at least some of its various sub-components may be implemented in hardware, software executed by a processor, firmware, or any combination thereof. If implemented in software executed by a processor, the functions of the feature detector 620 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The feature detector 620 and/or at least some of its various sub-components may be physically located at various positions, including being distributed such that portions of functions are implemented at different physical locations by one or more physical devices. In some examples, the feature detector 620 and/or at least some of its various sub-components may be a separate and distinct component in accordance with various examples of the present disclosure. In other examples, the feature detector 620 and/or at least some of its various sub-components may be combined with one or more other hardware components, including but not limited to a receiver, a transmitter, a transceiver, one or more other components described in the present disclosure, or a combination thereof in accordance with various examples of the present disclosure.

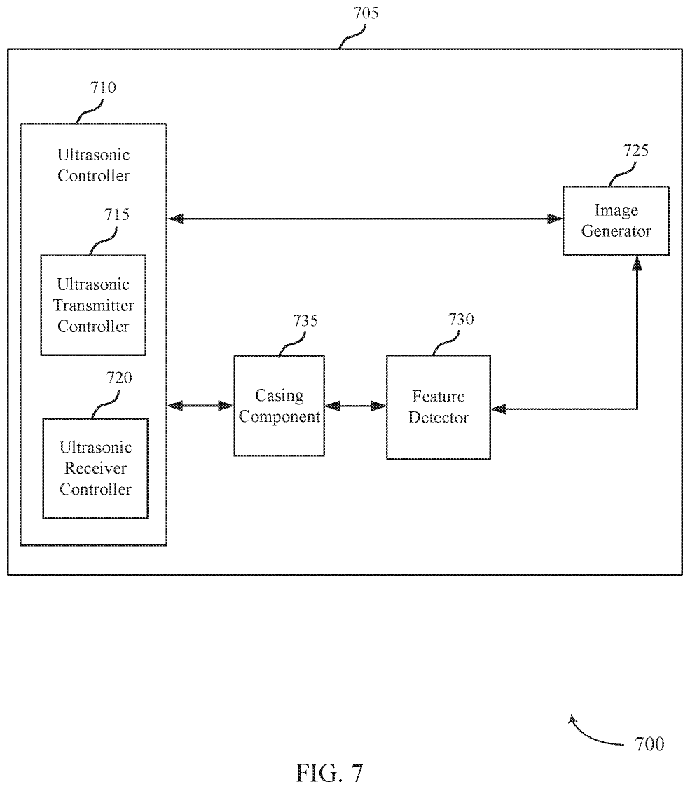

FIG. 7 shows an example block diagram 700 of a system 705 that supports ultrasonic inspection for ceramic structures in accordance with examples of the present disclosure. System 705 may be referred to as an electronic apparatus, and may be an example of a component of a controller.

System 705 may comprise an ultrasonic controller 710, an ultrasonic transmitter controller 715, and an ultrasonic receive controller 720. System 705 may also comprise an image generator 725, a feature detector 730, and a casing component 735. These components may be in electronic communication with each other and may perform one or more of the functions described herein. In some cases, ultrasonic transmitter controller 715 and ultrasonic receiver controller 720 may be a component of the ultrasonic controller 710. Energy beam controller 710 may be in electronic communication with the stage controller 715. These components may also be in electronic communication with other components, both inside and outside of system 705, in addition to components not listed above, via other components, connections, or busses.

The ultrasonic transmitter controller 715 may be configured to transmit an ultrasonic waveform through the ceramic structure, where the ceramic structure comprises two opposing ends and one or more outer faces extending between the two opposing ends, the one or more outer faces being at least partially enclosed by a casing and the ultrasonic transmitter being positioned adjacent to a first of the two opposing ends. In some cases, the ultrasonic transmitter controller 715 may transmit the ultrasonic waveform through an air-ceramic structure interface at the first of the two opposing ends. The ultrasonic transmitter controller 715 may be configured to adjusting a transducer speed of the ultrasonic transmitter. In some cases, the ultrasonic transmitter controller 715 may be configured to adjust a signal strength or gain of the ultrasonic waveform.

The ultrasonic transmitter controller 715, or at least some of its various sub-components may be implemented in hardware, software executed by a processor, firmware, or any combination thereof. If implemented in software executed by a processor, the functions of the ultrasonic transmitter controller 715 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure.

The ultrasonic transmitter controller 715 and/or at least some of its various sub-components may be physically located at various positions, including being distributed such that portions of functions are implemented at different physical locations by one or more physical devices. In some examples, the ultrasonic transmitter controller 715 and/or at least some of its various sub-components may be a separate and distinct component in accordance with various examples of the present disclosure. In other examples, the ultrasonic transmitter controller 715 and/or at least some of its various sub-components may be combined with one or more other hardware components, including but not limited to a receiver, a transmitter, a transceiver, one or more other components described in the present disclosure, or a combination thereof in accordance with various examples of the present disclosure.

The ultrasonic receiver controller 720 may be configured to receive a propagated waveform positioned adjacent to a second of the two opposing ends, the propagated waveform being the ultrasonic waveform after traversal of the ceramic structure. In some cases, the ultrasonic receiver controller 720 may be configured to scan the ceramic structure using the ultrasonic receiver to map an internal structure of the ceramic structure based at least in part on the propagated waveform, where the internal structure indicates the one or more detected features. The ultrasonic receiver controller 720 may be configured to scan the ceramic structure using the ultrasonic receiver to map an internal structure of the ceramic structure based at least in part on the adjusted transducer speed.

The ultrasonic receiver controller 720, or at least some of its various sub-components may be implemented in hardware, software executed by a processor, firmware, or any combination thereof. If implemented in software executed by a processor, the functions of the ultrasonic receiver controller 720 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure.

The ultrasonic receiver controller 720 and/or at least some of its various sub-components may be physically located at various positions, including being distributed such that portions of functions are implemented at different physical locations by one or more physical devices. In some examples, the ultrasonic receiver controller 720 and/or at least some of its various sub-components may be a separate and distinct component in accordance with various examples of the present disclosure. In other examples, the ultrasonic receiver controller 720 and/or at least some of its various sub-components may be combined with one or more other hardware components, including but not limited to a receiver, a transmitter, a transceiver, one or more other components described in the present disclosure, or a combination thereof in accordance with various examples of the present disclosure.

In some cases, ultrasonic controller 710 may be in electronic communication with the image generator 725. The image generator 725 may generate an image based at least in part on the propagated waveform, the image illustrating at least a portion of the casing and one or more detected features of the ceramic structure at the one or more outer faces of the ceramic structure adjacent to the casing. In some cases, the image generator 725 may generate the image based at least in part on the scanning.

The feature detector 730 may be in electronic communication with the image generator 725. For example, the feature detector 730 may detect a feature of the ceramic structure at the one or more outer faces of the ceramic structure, the feature being detectable based at least in part on the one or more outer faces being at least partially enclosed by the casing. In some cases, the feature detector 730 may detect a feature of the ceramic structure in the image based at least in part on the adjusted signal strength or gain. In some cases, the feature detector 730 may identify the one or more detected features of the ceramic structure based at least in part on discontinuities illustrated in the image.

The ultrasonic controller 710 may be in electronic communication with a casing component 735. The casing component 735 may enclose the one or more outer faces of the ceramic structure with the casing, where the casing has a first acoustic impedance that is within a predetermined range of a second acoustic impedance of the ceramic structure. In some cases, the casing component 735 may slide the casing around the ceramic structure. In other examples, the casing component 735 may couple first and second body portions of the casing around the ceramic structure.

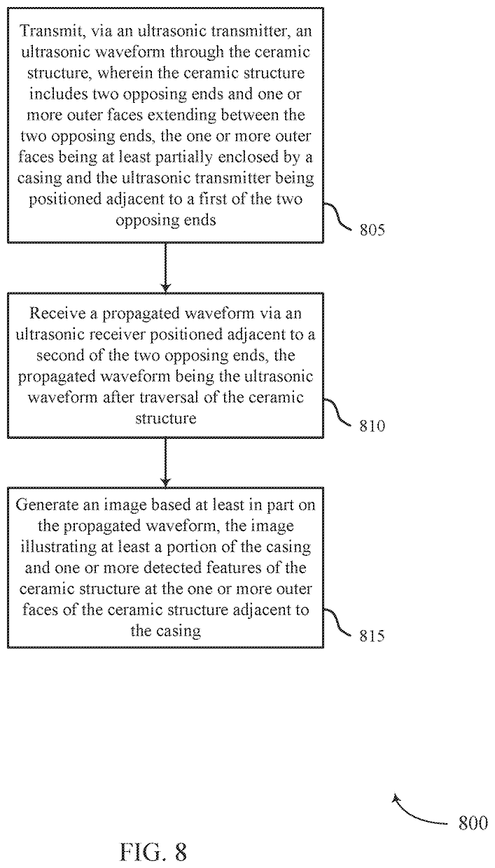

FIG. 8 illustrates a method 800 that supports ultrasonic inspection for ceramic structures in accordance with examples of the present disclosure. The operations of method 800 may be implemented by a device or its components as described herein. For example, the operations of method 800 may be performed by a system 705 and 805 as described with reference to FIGS. 6 and 7. In some examples, a device may execute a set of instructions to control the functional elements of the device to perform the functions described below. Additionally or alternatively, a device may perform aspects of the functions described below using special-purpose hardware.

At block 805, the method may comprise transmitting, via an ultrasonic transmitter, an ultrasonic waveform through the ceramic structure, where the ceramic structure comprises two opposing ends and one or more outer faces extending between the two opposing ends, the one or more outer faces being at least partially enclosed by a casing and the ultrasonic transmitter being positioned adjacent to a first of the two opposing ends. The operations of 805 may be performed according to the methods described herein. In some examples, aspects of the operations of 805 may be performed by a ultrasonic transmitter controller as described with reference to FIG. 7.

At block 810, the method may comprise receiving a propagated waveform via an ultrasonic receiver positioned adjacent to a second of the two opposing ends, the propagated waveform being the ultrasonic waveform after traversal of the ceramic structure. The operations of 810 may be performed according to the methods described herein. In some examples, aspects of the operations of 810 may be performed by ultrasonic receiver controller as described with reference to FIG. 7.

At block 815, the method may comprise generating an image based at least in part on the propagated waveform, the image illustrating at least a portion of the casing and one or more detected features of the ceramic structure at the one or more outer faces of the ceramic structure adjacent to the casing. The operations of 815 may be performed according to the methods described herein. In some examples, aspects of the operations of 815 may be performed by an image generator as described with reference to FIG. 7.

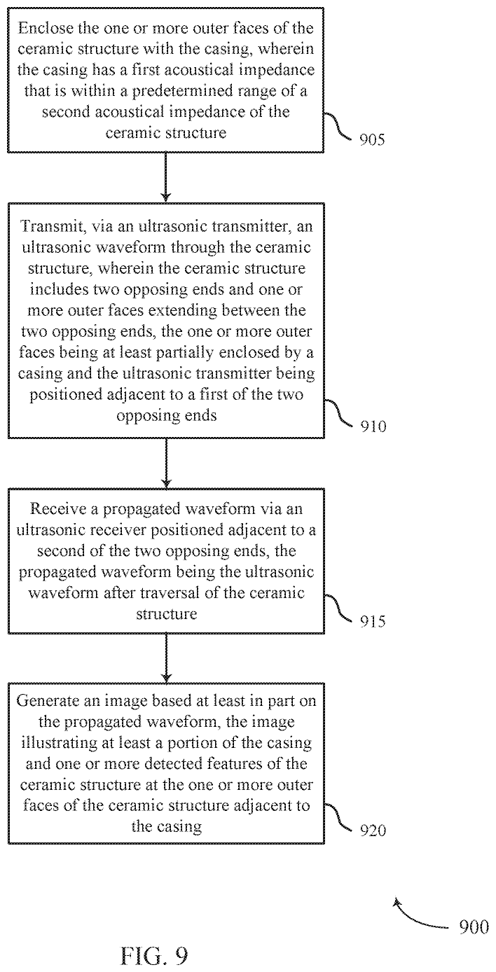

FIG. 9 illustrates a method 900 that supports ultrasonic inspection for ceramic structures in accordance with examples of the present disclosure. The operations of method 900 may be implemented by a device or its components as described herein. For example, the operations of method 900 may be performed by a system 705 and 805 as described with reference to FIGS. 6 and 7. In some examples, a device may execute a set of instructions to control the functional elements of the device to perform the functions described below. Additionally or alternatively, a device may perform aspects of the functions described below using special-purpose hardware.

At block 905, the method may comprise enclosing the one or more outer faces of the ceramic structure with the casing, where the casing has a first acoustic impedance that is within a predetermined range of a second acoustic impedance of the ceramic structure. The operations of 905 may be performed according to the methods described herein. In some examples, aspects of the operations of 905 may be performed by a casing component as described with reference to FIG. 7.

At block 910, the method may comprise transmitting, via an ultrasonic transmitter, an ultrasonic waveform through the ceramic structure, where the ceramic structure comprises two opposing ends and one or more outer faces extending between the two opposing ends, the one or more outer faces being at least partially enclosed by a casing and the ultrasonic transmitter being positioned adjacent to a first of the two opposing ends. The operations of 910 may be performed according to the methods described herein. In some examples, aspects of the operations of 910 may be performed by ultrasonic transmitter controller as described with reference to FIG. 7.

At block 915, the method may comprise receiving a propagated waveform via an ultrasonic receiver positioned adjacent to a second of the two opposing ends, the propagated waveform being the ultrasonic waveform after traversal of the ceramic structure. The operations of 915 may be performed according to the methods described herein. In some examples, aspects of the operations of 915 may be performed by ultrasonic receiver controller as described with reference to FIG. 7.

At block 920, the method may comprise generating an image based at least in part on the propagated waveform, the image illustrating at least a portion of the casing and one or more detected features of the ceramic structure at the one or more outer faces of the ceramic structure adjacent to the casing. The operations of 920 may be performed according to the methods described herein. In some examples, aspects of the operations of 920 may be performed by an image generator as described with reference to FIG. 7.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for detecting features of a ceramic structure, the method comprising:
transmitting, via an ultrasonic transmitter, an ultrasonic waveform through the ceramic structure, wherein the ceramic structure comprises two opposing ends and one or more outer faces extending between the two opposing ends, wherein the one or more outer faces are at least partially enclosed by a casing, and wherein the ultrasonic transmitter is positioned adjacent to a first of the two opposing ends;
receiving a propagated waveform via an ultrasonic receiver positioned adjacent to a second of the two opposing ends, the propagated waveform being the ultrasonic waveform after traversal of the ceramic structure; and
generating an image based at least in part on the propagated waveform, wherein the image illustrates at least a portion of the casing and is capable of illustrating one or more detected features of the ceramic structure at the one or more outer faces of the ceramic structure adjacent to the casing.

2. The method of claim 1, further comprising:
enclosing the one or more outer faces of the ceramic structure with the casing, wherein the casing has a first acoustic impedance that is within a predetermined range of a second acoustic impedance of the ceramic structure.

3. The method of claim 2, wherein the enclosing the one or more outer faces further comprises:
sliding the casing around the ceramic structure.

4. The method of claim 2, wherein the enclosing the one or more outer faces further comprises:
coupling first and second body portions of the casing around the ceramic structure.

5. The method of claim 1, wherein the transmitting the ultrasonic waveform through the ceramic structure further comprises:
transmitting the ultrasonic waveform through an air-ceramic structure interface at the first of the two opposing ends.

6. The method of claim 1, further comprising:
detecting a feature of the ceramic structure at the one or more outer faces of the ceramic structure, the feature being detectable based at least in part on the one or more outer faces being at least partially enclosed by the casing.

7. (canceled)

8. The method of claim 1, wherein generating the image further comprises:
scanning the ceramic structure using the ultrasonic receiver to map an internal structure of the ceramic structure based at least in part on the propagated waveform, wherein the internal structure indicates the one or more detected features.

9. The method of claim 1, further comprising:
identifying the one or more detected features of the ceramic structure based at least in part on discontinuities illustrated in the image.

10. The method of claim 1, further comprising:
adjusting a transducer speed of the ultrasonic transmitter;
scanning the ceramic structure using the ultrasonic receiver to map an internal structure of the ceramic structure based at least in part on the adjusted transducer speed; and
generating the image based at least in part on the scanning.

11. The method of claim 1, wherein the ceramic structure comprises a honeycomb filter.

12. A casing for a honeycomb filter structure comprising:
a sleeve material having a first acoustic impedance that is within a predetermined range of a second acoustic impedance of a honeycomb filter structure having two opposing ends and one or more outer faces extending between the two opposing ends;
wherein an encasing face of the sleeve material is configured to facilitate encasement of at least a portion of the one or more outer faces of the honeycomb filter structure by the sleeve material, the encasing face of the sleeve material being adjacent to the one or more outer faces of the honeycomb filter structure upon encasement of the honeycomb filter structure.

13. The casing of claim 12, further comprising:
an encasing mechanism configured to couple first and second encasing portions of the encasing face, wherein the first and second encasing portions surround at least the portion of the one or more outer faces of the honeycomb filter structure upon encasement of the honeycomb filter structure when the first and second encasing portions are coupled.

14. The casing of claim 12, further comprising:
an internal lining material positioned between the encasing face and the one or more outer faces of the honeycomb filter structure upon encasement of the honeycomb filter structure.

15. The casing of claim 14, wherein the internal lining material is comprised of a polymer material, a Styrofoam material, a rubber material, clay, or any combination thereof.

16. The casing of claim 12, wherein the encasing face facilitates encasement of at least the portion of the one or more outer faces of the honeycomb filter structure by the sleeve material in a horizontal or vertical direction.

17. (canceled)

18. The casing of claim 12, wherein a cross-sectional shape of the casing is different from a cross-sectional shape of the honeycomb filter structure.

19. The casing of claim 12, wherein the sleeve material comprises a polymer material, a Styrofoam material, a rubber material, clay, a ceramic material, a metallic material, or any combination thereof.

20. A system comprising:
an ultrasonic transmitter positioned adjacent to a first of two opposing ends of a porous ceramic structure, wherein one or more outer faces extending between the two opposing ends of the porous ceramic structure are at least partially enclosed by a casing, wherein the ultrasonic transmitter is configured to transmit an ultrasonic waveform through the porous ceramic structure;
an ultrasonic receiver positioned adjacent to a second of the two opposing ends and configured to receive a propagated waveform of the ultrasonic waveform after traversal of the porous ceramic structure; and
a processor configured in combination with the ultrasonic receiver to generate an image based at least in part on the propagated waveform, wherein the image illustrates at least a portion of the casing and is capable of illustrating one or more detected features of the porous ceramic structure at the one or more outer faces of the porous ceramic structure adjacent to the casing.

21. (canceled)

22. (canceled)

23. (canceled)

24. The system of claim 20, wherein the casing surrounds the one or more outer faces of the porous ceramic structure and comprises a polymer material, a Styrofoam material, a rubber material, clay, a ceramic material, a metallic material, or any combination thereof.

25. The system of claim 20, further comprising:
a base plate configured to support one of the two opposing ends of the porous ceramic structure, the base plate being positioned perpendicular to an axis between the ultrasonic transmitter and the ultrasonic receiver.
